(19) United States
(12) Patent Application Publication
(10) Pub. No.: US 2023/0330603 A1
(43) Pub. Date: Oct. 19, 2023

(54) SEPARATION MEMBRANE COMPLEX AND METHOD OF PRODUCING SEPARATION MEMBRANE COMPLEX

(71) Applicant: NGK INSULATORS, LTD., Nagoya-City (JP)

(72) Inventor: Makoto MIYAHARA, Tajimi-City (JP)

(73) Assignee: NGK INSULATORS, LTD., Nagoya-City (JP)

(21) Appl. No.: 18/338,493

(22) Filed: Jun. 21, 2023

Related U.S. Application Data
(63) Continuation of application No. PCT/JP2021/041385, filed on Nov. 10, 2021.

(30) Foreign Application Priority Data
Jan. 28, 2021 (JP) 2021-011640

(51) Int. Cl. B01D 69/02; B01D 69/10; B01D 71/02; B01D 69/04; B01D 53/22; B01J 20/28; B01J 20/32; B01J 20/30; B01J 20/10; B01J 20/08

(52) U.S. Cl. CPC B01D 69/02; B01D 69/108; B01D 71/0281; B01D 69/105; B01D 69/04; B01D 53/228; B01J 20/28035; B01J 20/28004; B01J 20/3223; B01J 20/3204; B01J 20/3042; B01J 20/103; B01J 20/08; B01D 2325/04; B01D 2325/06; B01D 2325/0231; B01D 2323/06; B01D 2257/504

(57) ABSTRACT

A separation membrane complex includes a porous support, a dense part covering one surface of the support from a boundary position toward one side in a predetermined direction on the surface, and a separation membrane covering the surface from the boundary position toward the other side and covering the dense part in the vicinity of the boundary position. In a case where, in a cross section, within a specified range from the boundary position toward the one side in the predetermined direction up to 30 μm, a maximum angle among angles formed of the surface and lines connecting respective positions on a surface of the dense part on a side of the separation membrane and the boundary position is acquired as an evaluation angle, a maximum value of four evaluation angles at four measurement positions is not smaller than 5 degrees and not larger than 45 degrees.

### CROSS-REFERENCE TO RELATED APPLICATIONS

The present application is a continuation application of International Application No. PCT/JP2021/041385 filed on Nov. 10, 2021, which claims priority to Japanese Patent Application No. 2021-011640 filed on Jan. 28, 2021. The contents of these applications are incorporated herein by reference in their entirety.

### TECHNICAL FIELD

The present invention relates to a separation membrane complex and a method of producing a separation membrane complex.

### BACKGROUND ART

Conventionally, a separation membrane complex in which a separation membrane is provided on (supported by) a porous support has been used. In the separation membrane complex, a substance with high permeability out of a supplied mixed substance selectively permeates the separation membrane, and separation is thereby performed. In the separation membrane complex, in order to prevent a substance from moving from a supply-side space to a permeate-side space without permeating the separation membrane, provided is a dense part on part of a surface of the support. Typically, the dense part is provided at an end portion of the surface of the support on which the separation membrane is provided, and the separation membrane and the dense part partially overlap each other on the surface. More in detail, the dense part covers the surface from a predetermined boundary position on the surface toward one side and the separation membrane covers the surface from the boundary position toward the other side and also covers the dense part in the vicinity of the boundary position.

On the other hand, various considerations have been made on a composition of the dense part and a method of forming the same. In Japanese Patent Application Laid Open Gazette No. 2009-66528 (Document 1) and Patent Publication No. 5810083 (Document 2), for example, disclosed is glass seal containing a glass component and ceramic particles dispersed in the glass component. Patent Publication No. 4748730 (Document 3) discloses a method of sealing an end surface in a ceramic filter including a base material formed of a ceramic porous body in which a lot of cells are formed and a filtration membrane formed on an inner wall surface of each cell. In the sealing method, a slurry for a sealing member is applied onto the end surface of the base material in two stages, i.e., a stamp coating and a spray coating, to have a thickness of 0.2 mm or more, and part of the slurry is caused to enter the inner wall surface of each cell adjacent to the end surface in a depth of 0.5 to 3 mm, to be adhered thereon. After that, by performing sintering, the dense part is formed.

Further, in Japanese Patent Application Laid Open Gazette No. 2019-145612 (Document 4), described is a method of measuring and calculating an average roughness of a surface of an insulating substrate at a portion where the insulating substrate and a sealing resin are in close contact with each other. In the method, a SEM image is prepared by imaging a cross section of the insulating substrate by a scanning electron microscope (SEM), the SEM image is binarized to prepare image data of a surface shape, the image data is converted into two-dimensional coordinate data by using image digitization software, and the average roughness is obtained by using a predetermined formula.

In the vicinity of the boundary position, a stress is easily caused by differential thermal expansion due to a heat treatment or the like and there sometimes occurs a crack or the like of the separation membrane, and in this case, the separation performance of the separation membrane complex is largely degraded.

### SUMMARY OF THE INVENTION

The present invention is intended for a separation membrane complex, and it is an object of the present invention to suppress occurrence of a crack or the like of a separation membrane in the vicinity of a boundary position and suppress degradation of separation performance of a separation membrane complex.

The separation membrane complex according to one preferred embodiment of the present invention includes a porous support, a dense part covering one surface of the support from a position defined as a boundary position in a predetermined direction on the surface toward one side in the predetermined direction, and a separation membrane covering the surface of the support from the boundary position toward the other side in the predetermined direction on the surface and covering the dense part in vicinity of the boundary position. In the separation membrane complex of the present invention, in a case where with respect to each of four measurement positions set equally in a direction perpendicular to the predetermined direction on the surface of the support, in a cross section perpendicular to the surface of the support and along the predetermined direction, within a specified range from the boundary position toward the one side in the predetermined direction up to 30 μm, a maximum angle among angles formed of the surface of the support and lines connecting respective positions on a surface of the dense part on a side of the separation membrane and the boundary position is acquired as an evaluation angle, a maximum value of four evaluation angles at the four measurement positions is not smaller than 5 degrees and not larger than 45 degrees.

According to the present invention, it is possible to suppress occurrence of a crack or the like of the separation membrane in the vicinity of the boundary position and suppress degradation of separation performance of the separation membrane complex.

Preferably, a closed porosity in the dense part is not higher than 10% within the specified range of the cross section.

Preferably, a thickness of the separation membrane is not larger than 5 μm, and within the specified range of the cross section, an average roughness of the surface of the dense part on the side of the separation membrane is not less than 0.01 μm and not more than 10 μm, the average roughness being calculated with a straight line along the surface of the dense part as a reference.

Preferably, a thickness of the separation membrane is not larger than 5 μm, and a surface roughness Ra of the dense part in a non-existent region of the separation membrane is not less than 0.01 μm and not more than 1 μm.

Preferably, the surface of the support is a cylindrical surface along the predetermined direction, the four measurement positions are set on the cylindrical surface at 90-degree intervals in a circumferential direction, and an angle of a range of the four evaluation angles at the four measurement positions is not larger than 15 degrees.

Preferably, the surface of the support is a cylindrical surface along the predetermined direction, the boundary position is provided at an end portion of the support on the one side in the predetermined direction, and the dense part covers an end surface of the support on the one side.

The present invention is also intended for a method of producing a separation membrane complex. The method of producing a separation membrane complex according to one preferred embodiment of the present invention includes a) applying a slurry for formation of a dense part so as to cover one surface of a porous support from a position defined as a boundary position in a predetermined direction on the surface toward one side in the predetermined direction, b) drying the slurry in a state where an end portion on the one side of the support in the predetermined direction is arranged on a lower side and an end portion on the other side is arranged on an upper side, or drying the slurry by blowing gas along the surface from the other side of the support toward the one side, c) forming a dense part by sintering the slurry, and d) forming a separation membrane which covers the surface of the support from the boundary position toward the other side in the predetermined direction on the surface and covers the dense part in vicinity of the boundary position. In the method of producing a separation membrane complex of the present invention, a viscosity of the slurry in the operation a) is not lower than 2 dPa·s and not higher than 30 dPa·s.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a cross-sectional view of a separation membrane complex;

FIG. 2 is a cross-sectional view enlargedly showing part of the separation membrane complex;

FIG. 3 is a cross-sectional view enlargedly showing the vicinity of one end portion of the separation membrane complex;

FIG. 4 is a cross-sectional view enlargedly showing the vicinity of a boundary position of the separation membrane complex;

FIG. 5 is a cross-sectional view enlargedly showing the vicinity of the boundary position of the separation membrane complex;

FIG. 6 is a flowchart showing a flow for producing the separation membrane complex;

FIG. 7 is a cross-sectional view showing a support;

FIG. 8 is a cross-sectional view showing a separation membrane complex of Comparative Example;

FIG. 9 is a perspective view showing the support; and

FIG. 10 is a view showing a separation apparatus.

### DESCRIPTION OF EMBODIMENTS

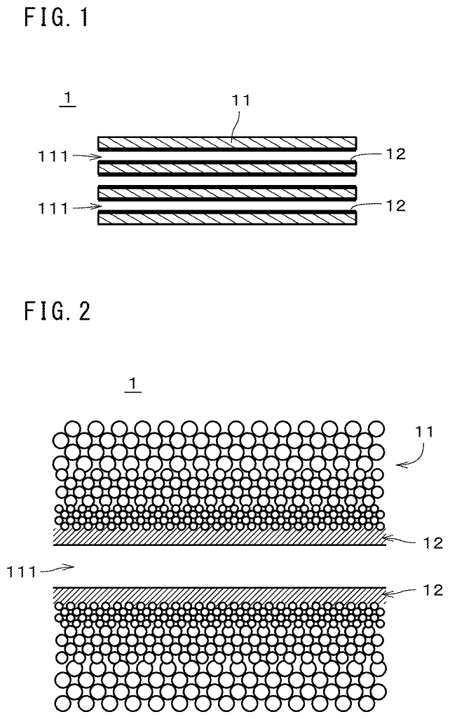

FIG. 1 is a cross-sectional view showing a separation membrane complex 1, which shows a cross section in parallel to a longitudinal direction of a support 11 described later. FIG. 2 is a cross-sectional view enlargedly showing part of the separation membrane complex 1. In FIG. 1, a dense part 13 described later is not shown. The separation membrane complex 1 is a zeolite membrane complex and includes a porous support 11 and a zeolite membrane 12 which is a separation membrane provided on the support 11. The zeolite membrane 12 is at least obtained by forming zeolite on a surface of the support 11 in a membrane form and does not include a membrane obtained by simply dispersing zeolite particles in an organic membrane. Further, the zeolite membrane 12 may contain two or more types of zeolites which are different in the structure and the composition. In FIG. 1, the zeolite membrane 12 is represented by a thick line. In FIG. 2, the zeolite membrane 12 is hatched. In FIG. 2, the thickness of the zeolite membrane 12 is shown larger than the actual thickness.

The separation membrane complex 1 may be other than the zeolite membrane complex, and instead of the zeolite membrane 12, an inorganic membrane formed of an inorganic substance other than zeolite or a membrane other than the inorganic membrane may be formed on the support 11 as the separation membrane. Further, a separation membrane in which zeolite particles are dispersed in an organic membrane may be used. In the following description, it is assumed that the separation membrane is the zeolite membrane 12.

The support 11 is a porous member that gas and liquid can permeate. In the exemplary case shown in FIG. 1, the support 11 is a monolith-type support having an integrally and continuously molded columnar main body provided with a plurality of through holes 111 each extending in the longitudinal direction (i.e., a left and right direction in FIG. 1). In the exemplary case shown in FIG. 1, the support 11 has a substantially columnar shape. A cross section perpendicular to the longitudinal direction of each of the through holes 111 (i.e., cells) is, for example, substantially circular. In FIG. 1, the diameter of each through hole 111 is larger than the actual diameter, and the number of through holes 111 is smaller than the actual number. The zeolite membrane 12 is formed over an inner peripheral surface of the through hole 111, covering substantially the entire inner peripheral surface of the through hole 111.

The length of the support 11 (i.e., the length in the left and right direction of FIG. 1) is, for example, 10 cm to 200 cm. The outer diameter of the support 11 is, for example, 0.5 cm to 30 cm. The distance between the central axes of adjacent through holes 111 is, for example, 0.3 mm to 10 mm. The surface roughness (Ra) of the support 11 is, for example, 0.1 μm to 5.0 μm, and preferably 0.2 μm to 2.0 μm. Further, the shape of the support 11 may be, for example, honeycomb-like, flat plate-like, tubular, cylindrical, columnar, polygonal prismatic, or the like. When the support 11 has a tubular or cylindrical shape, the thickness of the support 11 is, for example, 0.1 mm to 10 mm.

As the material for the support 11, various materials (for example, ceramics or a metal) may be adopted only if the materials ensure chemical stability in the process step of forming the zeolite membranes 12 and the dense part 13 on the surface thereof. In the present preferred embodiment, the support 11 is formed of a ceramic sintered body. Examples of the ceramic sintered body which is selected as a material for the support 11 include alumina, silica, mullite, zirconia, titania, yttria, silicon nitride, silicon carbide, and the like. In the present preferred embodiment, the support 11 contains at least one type of alumina, silica, and mullite.

The support 11 may contain an inorganic binder. As the inorganic binder, at least one of titania, mullite, easily sinterable alumina, silica, glass frit, a clay mineral, and easily sinterable cordierite can be used.

The average pore diameter of the support 11 is, for example, 0.01 μm to 70 μm, and preferably 0.05 μm to 25 μm. The average pore diameter of the support 11 in the vicinity of the surface on which the zeolite membrane 12 is formed is 0.01 μm to 1 μm, and preferably 0.05 μm to 0.5 μm. The average pore diameter can be measured by using, for example, a mercury porosimeter, a perm porometer, or a nano-perm porometer. Regarding the pore diameter distribution of the entire support 11 including the surface and the inside thereof, D5 is, for example, 0.01 μm to 50 μm, D50 is, for example, 0.05 μm to 70 μm, and D95 is, for example, 0.1 μm to 2000 μm. The porosity of the support 11 in the vicinity of the surface on which the zeolite membrane 12 is formed is, for example, 20% to 60%.

The support 11 has, for example, a multilayer structure in which a plurality of layers with different average pore diameters are layered in a thickness direction. The average pore diameter and the sintered particle diameter in a surface layer including the surface on which the zeolite membrane 12 is formed are smaller than those in layers other than the surface layer. The average pore diameter in the surface layer of the support 11 is, for example, 0.01 μm to 1 μm, and preferably 0.05 μm to 0.5 μm. When the support 11 has a multilayer structure, the materials for the respective layers can be those described above. The materials for the plurality of layers constituting the multilayer structure may be the same as or different from one another.

The zeolite membrane 12 is a porous membrane having micropores. The zeolite membrane 12 can be used as a separation membrane for separating a specific substance from a mixed substance in which a plurality of types of substances are mixed, by using a molecular sieving function. As compared with the specific substance, any one of the other substances is harder to permeate the zeolite membrane 12. In other words, the permeance of any other substance through the zeolite membrane 12 is smaller than that of the above specific substance.

The thickness of the zeolite membrane 12 is, for example, 0.05 μm to 30 μm, preferably 0.1 μm to 20 μm, and further preferably 0.5 μm to 10 μm. When the thickness of the zeolite membrane 12 is increased, the separation performance increases. When the thickness of the zeolite membrane 12 is reduced, the permeance increases. The surface roughness (Ra) of the zeolite membrane 12 is, for example, 5 μm or less, preferably 2 μm or less, more preferably 1 μm or less, and further preferably 0.5 μm or less.

The average pore diameter of the zeolite membrane 12 is, for example, 1 nm or less. The average pore diameter of the zeolite membrane 12 is preferably not smaller than 0.2 nm and not larger than 0.8 nm, more preferably not smaller than 0.3 nm and not larger than 0.5 nm, and further preferably not smaller than 0.3 nm and not larger than 0.4 nm. The average pore diameter of the zeolite membrane 12 is smaller than that of the support 11 in the vicinity of the surface on which the zeolite membrane 12 is formed.

When the maximum number of membered rings of the zeolite forming the zeolite membrane 12 is n, an arithmetic average of the short diameter and the long diameter of an n-membered ring pore is defined as the average pore diameter. The n-membered ring pore refers to a pore in which the number of oxygen atoms in the part where the oxygen atoms and T atoms are bonded to form a ring structure is n. When the zeolite has a plurality of n-membered ring pores having the same n, an arithmetic average of the short diameters and the long diameters of all the n-membered ring pores is defined as the average pore diameter of the zeolite. Thus, the average pore diameter of the zeolite membrane is uniquely determined depending on the framework structure of the zeolite and can be obtained from values disclosed in “Database of Zeolite Structures” [online], internet <URL: http://www.iza-structure.org/databases/> of the International Zeolite Association.

There is no particular limitation on the type of the zeolite forming the zeolite membrane 12, but the zeolite membrane 12 may be formed of, for example, AEI-type, AEN-type, AFN-type, AFV-type, AFX-type, BEA-type, CHA-type, DDR-type, ERI-type, ETL-type, FAU-type (X-type, Y-type), GIS-type, KFI-type, LEV-type, LTA-type, MEL-type, MER-type, MFI-type, MOR-type, PAU-type, RHO-type, SAT-type, SOD-type zeolite, or the like.

From the viewpoint of an increase in the permeance of CO₂ and an improvement in the separation performance, it is preferable that the maximum number of membered rings of the zeolite should be 8 or less (for example, 6 or 8). The zeolite membrane 12 is formed of, for example, DDR-type zeolite. In other words, the zeolite membrane 12 is a zeolite membrane formed of the zeolite having a structure code of “DDR” which is designated by the International Zeolite Association. In this case, the unique pore diameter of the zeolite forming the zeolite membrane 12 is 0.36 nm×0.44 nm, and the average pore diameter is 0.40 nm.

The zeolite membrane 12 contains, for example, silicon (Si). The zeolite membrane 12 may contain, for example, any two or more of Si, aluminum (Al), and phosphorus (P). In this case, as the zeolite forming the zeolite membrane 12, zeolite in which atoms (T-atoms) located at the center of an oxygen tetrahedron (TO₄) constituting the zeolite include only Si or Si and Al, AlPO-type zeolite in which T-atoms include Al and P, SAPO-type zeolite in which T-atoms include Si, Al, and P, MAPSO-type zeolite in which T-atoms include magnesium (Mg), Si, Al, and P, ZnAPSO-type zeolite in which T-atoms include zinc (Zn), Si, Al, and P, or the like can be used. Some of the T-atoms may be replaced by other elements.

When the zeolite membrane 12 contains Si atoms and Al atoms, the ratio of Si/Al in the zeolite membrane 12 is, for example, not less than 1 and not more than 100,000. The Si/Al ratio is preferably 5 or more, more preferably 20 or more, and further preferably 100 or more. In short, the higher the ratio is, the better. By adjusting the mixing ratio of an Si source and an Al source in a later-described starting material solution, or the like, it is possible to adjust the Si/Al ratio in the zeolite membrane 12. The zeolite membrane 12 may contain an alkali metal. The alkali metal is, for example, sodium (Na) or potassium (K).

In the separation membrane complex 1, the permeance of CO₂ through the zeolite membrane 12 at 20° C. to 400° C. is, for example, 100 nmol/m²·s·Pa or more. Further, the ratio (permeance ratio) of the permeance of CO₂ through the zeolite membrane 12 to the leakage (amount) of CH₄ at 20° C. to 400° C. is, for example, 100 or more. The permeance and the permeance ratio are those in a case where the partial pressure difference of CO₂ between the supply side and the permeate side of the zeolite membrane 12 is 1.5 MPa.

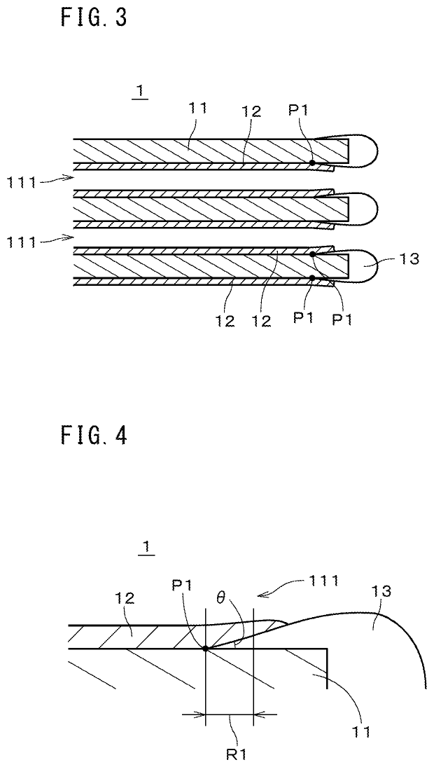

FIG. 3 is a view enlargedly showing the vicinity of one end portion of the separation membrane complex 1. In an exemplary separation membrane complex 1, a dense part 13 is provided on each end portion of the support 11 in the longitudinal direction. In FIG. 3, the cross section of the dense part 13 is shown with no hatch (the same applies to the other figures). The dense part 13 continuously covers a region of an end surface, other than the through hole 111, a region in the vicinity of the end surface in an outer peripheral surface of the support 11, and a region in the vicinity of the end surface in the inner peripheral surface of each through hole 111. The dense part 13 seals these regions in the support 11. The dense part 13 is a sealing part which prevents the inflow and outflow of gas from/to these regions. The length of the dense part 13 on the outer peripheral surface of the support 11 and on the inner peripheral surface of the through hole 111 in the longitudinal direction is, for example, 0.1 cm to 5.0 cm. The dense part 13 is formed of, for example, glass or a resin. Further, both ends of each through hole 111 in the longitudinal direction are not covered with the dense parts 13, and it is therefore possible for gas to flow in and out to/from the through hole 111 from/to both the ends thereof.

Herein, paying attention to the inner peripheral surface of each through hole 111, assuming a position in the vicinity of the end surface of the support 11 as a boundary position P1 on the inner peripheral surface, the dense part 13 covers the inner peripheral surface from the boundary position P1 toward the end surface side in the longitudinal direction. The boundary position P1 is a tip position of the dense part 13 inside the through hole 111. In FIG. 3, only some boundary positions P1 are each represented by a black point. Though typically the boundary position P1 in the longitudinal direction is substantially constant along the entire circumference in a circumferential direction (a circumferential direction of the inner peripheral surface) perpendicular to the longitudinal direction, the boundary position P1 in the longitudinal direction may vary to some degree along the circumferential direction. It is preferable that the boundary positions P1 in the longitudinal direction in the plurality of through holes 111 should be substantially constant, but the boundary position P1 may be different to some degree.

The already-described zeolite membrane 12 covers a substantially entire region between the respective dense parts 13 provided on both the end portions of the support 11 on the inner peripheral surface of each through hole 111. In other words, on the inner peripheral surface, the zeolite membrane 12 covers the inner peripheral surface from the boundary position P1 of each dense part 13 toward the side opposite to the dense part 13 in the longitudinal direction. Typically, the dense part 13 or the zeolite membrane 12 covers the entire inner peripheral surface of the through hole 111. Further, the zeolite membrane 12 also covers the dense part 13 in the vicinity of the boundary position P1. In the vicinity of the boundary position P1, provided is a composite part where the dense part 13 and the zeolite membrane 12 overlap each other. In the longitudinal direction, the length of a portion (the composite part) where the dense part 13 and the zeolite membrane 12 overlap each other is, for example, not larger than 50 μm, and preferably not larger than 10 μm.

FIG. 4 is a cross-sectional view enlargedly showing the vicinity of the boundary position P1 of the separation membrane complex 1. Like FIGS. 1 to 3, FIG. 4 shows the cross section perpendicular to the inner peripheral surface of the through hole 111 and along the longitudinal direction. In the separation membrane complex 1, as it goes from the boundary position P1 toward the end surface of the support 11 along the inner peripheral surface of the through hole 111, the thickness of the dense part 13 gradually increases. Actually, in the vicinity of the boundary position P1, an inclination of a surface of the dense part 13 is gentle. Further, the roughness (projections and depressions) of the surface of the dense part 13 is small. In other words, the surface of the dense part 13 is smooth.

As described earlier, the dense part 13 is covered with the zeolite membrane 12 in the vicinity of the boundary position P1. Since the inclination of the surface of the dense part 13 in the vicinity of the boundary position P1 is gentle, an angle at which the zeolite membrane 12 is bent at the boundary position P1 is small and occurrence of a crack of the zeolite membrane 12 due to stress concentration or the like (for example, occurrence of a crack caused by a stress generated by heating) is suppressed. Further, since the surface roughness of the dense part 13 in the vicinity of the boundary position P1 is small, occurrence of a defect (hole portion or the like) is suppressed on the dense part 13 and the zeolite membrane 12 formed on the dense part 13.

Herein, description will be made on a measurement of the inclination of the surface of the dense part 13 in the vicinity of the boundary position P1 and a measurement of the surface roughness. In the measurement of the inclination, by imaging a cross section of the separation membrane complex 1 shown in FIG. 4 by using a SEM (Scanning Electron Microscope), a SEM image is acquired. The magnification of the SEM image is, for example, 5000 times. Subsequently, in the SEM image, set is a specified range R1 (indicated by an arrow in FIG. 4) which is a range from the boundary position P1 toward the end surface side of the support 11 in the longitudinal direction up to 30 μm.

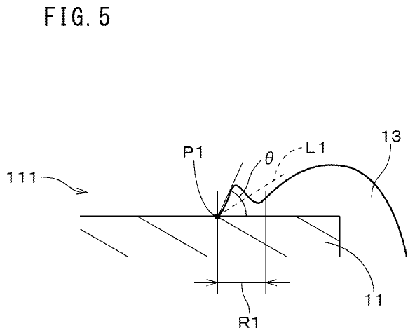

Within the specified range R1, a maximum angle among angles (hereinafter, referred to as “elevation angles from the boundary position P1”) formed of the inner peripheral surface of the through hole 111 and lines connecting respective positions on a surface of the dense part 13 on a side of the separation membrane 12 and the boundary position P1 is acquired as an evaluation angle θ. In the exemplary case of FIG. 4, also at any position within the specified range R1, the elevation angle from the boundary position P1 is substantially constant. As shown in FIG. 5, when the projections and depressions on the surface of the dense part 13 are large, since the elevation angle from the boundary position P1 at each position on the surface largely varies, the maximum elevation angle within the specified range R1 is determined as the above-described evaluation angle θ. Further, the exemplary case of FIG. 5 is used to describe a measurement of the evaluation angle θ, such large projections and depressions as shown in FIG. 5 are not generated on the surface of the actual dense part 13. In FIG. 5, the zeolite membrane 12 is not shown. When the evaluation angle θ can be appropriately acquired, it is not necessary to obtain the elevation angle from the boundary position P1 with respect to all the positions on the surface of the dense part 13 within the specified range R1.

As described earlier, in the separation membrane complex 1 of FIG. 3, the dense part 13 and the zeolite membrane 12 are formed on the inner peripheral surface of the through hole 111 which is a cylindrical surface along the longitudinal direction. In a case where the above-described evaluation angle θ is acquired with respect to each of four measurement positions set at 90-degree intervals (equally) in the circumferential direction on the cylindrical surface, a maximum value of the four evaluation angles θ at the four measurement positions is not smaller than 5 degrees and not larger than 45 degrees. An upper limit of the maximum value of the evaluation angle θ is preferably 43 degrees, and more preferably 40 degrees. As the maximum value of the evaluation angle θ becomes smaller, the angle at which the zeolite membrane 12 is bent in the vicinity of the boundary position P1 also becomes smaller and occurrence of a crack of the zeolite membrane 12 due to the stress concentration or the like is suppressed. Further, when the evaluation angle θ is not smaller than 5 degrees, it is possible to suppress occurrence of a defect due to the dense part 13 which becomes excessively thin in the vicinity of the boundary position P1.

Furthermore, an angle of a range of the four evaluation angles θ at the four measurement positions, in other words, a difference between the maximum value and the minimum value of the four evaluation angles θ is, for example, not larger than 15 degrees. As the range of the four evaluation angles θ becomes smaller, a variation in the shape of the dense part 13 in the circumferential direction also becomes smaller. The angle of the range of the four evaluation angles θ is preferably not larger than 12 degrees, and more preferably not larger than 10 degrees.

A measurement of the surface roughness of the dense part 13 in the vicinity of the boundary position P1 is performed pursuant to the method disclosed in Japanese Patent Application Laid Open Gazette No. 2019-145612 (Document 4). First, like in the above-described measurement of the evaluation angle θ, the SEM image representing the cross section of the separation membrane complex 1 is acquired. The same SEM image as used in the measurement of the evaluation angle θ may be used. Subsequently, as shown in FIG. 5, within the specified range R1, set is a straight line L1 along the surface of the dense part 13 on the side of the zeolite membrane 12 (not shown in FIG. 5). For example, two-dimensional coordinate data indicating the shape of the above-described surface is acquired from the SEM image and an approximate straight line of the shape of the above-described surface within the specified range R1 is obtained as the straight line L1 by the least squares method or the like using the two-dimensional coordinate data. After that, a surface roughness Za of the dense part 13 is obtained from Eq. 1.

$$Za = \frac{1}{N} {\sum }_{n = 1}^{N} \vert Zn \vert \qquad ( Eq . 1 )$$

In Eq. 1, Zn represents a difference between the two-dimensional coordinate data and the straight line L1 at each position n within the specified range R1 in the longitudinal direction. N represents a value obtained by dividing the width, 30 μm, of the specified range R1 by a calculation pitch. The calculation pitch is, for example, 0.01 μm, and in this case, N is 3000. Thus, within the specified range R1, the surface roughness Za of the dense part 13 is calculated with the straight line L1 along the surface of the dense part 13 on the side of the zeolite membrane 12 as a reference.

In the separation membrane complex 1, it is preferable that an average value of the roughnesses Za acquired at a plurality of measurement positions (e.g., the above-described four measurement positions), i.e., an average roughness Za should be not less than 0.01 μm and not more than 10 μm. An upper limit of the range of the average roughness Za is more preferably 5 μm, and further preferably 3 μm. It is thereby possible to suppress occurrence of a defect (hole portion or the like) in the dense part 13 and the zeolite membrane 12 formed on the dense part 13. A lower limit of the average roughness Za is preferably 0.05 μm, and more preferably 0.1 μm. It is thereby possible to increase adhesion of the zeolite membrane 12 to be formed on the dense part 13 and suppress occurrence of removal.

The measurement of the surface roughness of the dense part 13 may be performed in a non-existent region of the zeolite membrane 12 outside the specified range R1. The surface roughness Ra of the dense part 13 in the non-existent region of the zeolite membrane 12 is obtained as an average value of a plurality of surface roughnesses Ra by using, for example, a general-purpose three-dimensional surface structure analysis apparatus (e.g., NewView 7300 manufactured by Zygo Corporation) to measure a plurality of portions on the surface of the dense part 13. A surface roughness Ra itself at one portion on the surface may be adopted as the surface roughness Ra of the dense part 13. The surface roughness Ra of the dense part 13 is, for example, not less than 0.01 μm and not more than 1 μm. An upper limit of the range of the surface roughness Ra is preferably 0.8 μm, and more preferably 0.6 μm. The surface roughness Ra has a correlation with the average roughness Za, and as the surface roughness Ra becomes smaller, it is possible to more suppress occurrence of a defect (hole portion or the like) in the dense part 13 and the zeolite membrane 12 formed on the dense part 13.

In the separation membrane complex 1, within the specified range R1 in the cross section shown in FIG. 4, closed porosity in the dense part 13 is preferably 10% or less, and more preferably 8% or less. It is thereby possible to suppress a crack from occurring from a closed pore as a starting point. The closed porosity in the dense part 13 may be 0%. In the SEM image representing the cross section of the separation membrane complex 1, for example, the area of the dense part 13 within the specified range R1 and the area of the closed pore are calculated, and the closed porosity (the area ratio of the closed pore) in the SEM image can be obtained by dividing the area of the closed pore by the area of the dense part 13. It is preferable that the closed porosity in the dense part 13 should be obtained as an average value of the closed porosities in a plurality of SEM images.

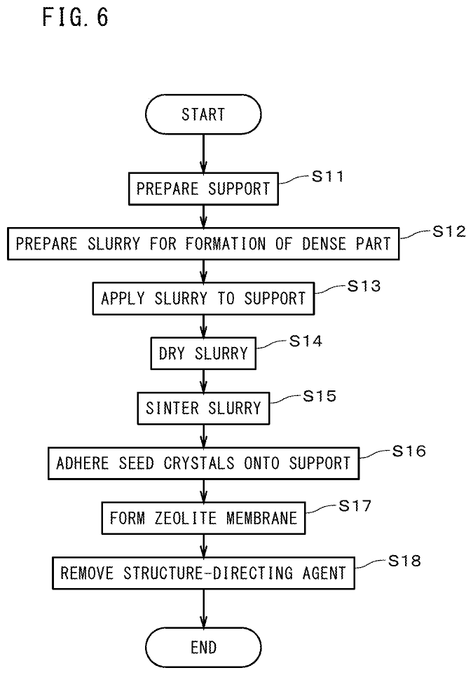

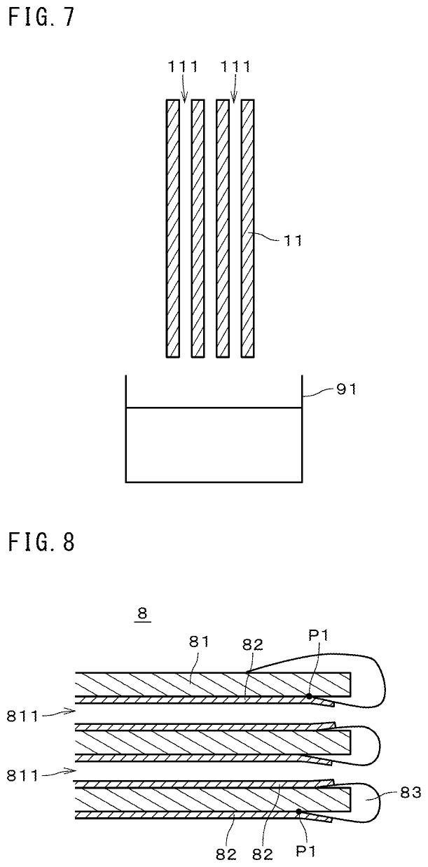

Next, with reference to FIG. 6, an exemplary flow of producing the separation membrane complex 1 will be described. In the production of the separation membrane complex 1, first, the support 11 is prepared (Step S11). Herein, as shown in FIG. 7, the monolith-type support 11 is prepared. In the support 11, a plurality of through holes 111 each extending in the longitudinal direction (the up-and-down direction of FIG. 7) are provided. After the support 11 is prepared, for example, an organic binder is added to glass powder and water is added thereto, to be mixed, and the slurry is thereby prepared. Then, the slurry is vacuum-degassed and a slurry for formation of the dense part is thereby prepared (Step S12). The viscosity of the slurry for formation of the dense part at 20° C. is not lower than 2 dPa·s (decipascal second) and not higher than 30 dPa·s. The viscosity of the slurry can be measured by using, for example, an ultrasonic desktop viscosity meter (FCV-100H manufactured by Fuji Ultrasonic Engineering Co., Ltd.). In the preparation of the slurry for formation of the dense part, degassing of the slurry may be omitted, or a thickener or a leveling agent may be added to the slurry as necessary. In the slurry for formation of the dense part, ceramic particles or the like may be mixed.

Subsequently, as shown in FIG. 7, the support 11 is held in a state where the end portion on one side of the support 11 in the longitudinal direction is arranged on a lower side and the end portion on the other side is arranged on an upper side, in other words, in a vertical orientation where the through hole 111 is substantially in parallel to the up-and-down direction. Then, the end portion (lower end portion) on the one side of the support 11 is immersed in the slurry for formation of the dense part in a container 91. After that, the support 11 is pulled up from the slurry at a predetermined speed (for example, 1 cm/s). The slurry is thereby applied to a region in the end surface on the one side of the support 11, other than the through holes 111, a region in the vicinity of the end surface on the outer peripheral surface of the support 11, and a region in the vicinity of the end surface on the inner peripheral surface of each through hole 111 (Step S13). Herein, paying attention to the inner peripheral surface of the through hole 111, in the process of Step S13, assuming one position in the longitudinal direction on the inner peripheral surface as the boundary position P1, the slurry for formation of the dense part is so applied as to cover the inner peripheral surface from the boundary position P1 toward the one side (the end surface side) in the longitudinal direction. Though application of the slurry is performed by immersing the end portion of the support 11 in the vertical orientation in the slurry in the present process example, the application of the slurry may be performed by any other method.

After the support 11 is pulled up from the slurry for formation of the dense part, with the state (in the vertical orientation) kept, where the end portion on the one side is arranged on a lower side and the end portion on the other side is arranged on an upper side, the slurry adhered to the end portion on the one side is dried (Step S14). Alternatively, the slurry is dried by blowing gas such as air or the like along the inner peripheral surface from the other side toward the one side of the support 11. The gas blowing speed is, for example, 1 to 30 m/s, preferably 5 to 20 m/s, and 15 m/s in the present process example. Thus, the slurry on the inner peripheral surface of the through hole 111 is dried, while being extended from the boundary position P1 toward the one side (the end surface side) in the longitudinal direction under its own weight or/and by gas blowing. In the case where the slurry is dried by blowing gas, the support 11 does not necessarily need to be supported in the vertical orientation, and the support 11 may be supported in any orientation such as in a horizontal orientation where the through hole 111 is substantially in parallel to a horizontal direction, or the like. In the support 11, the slurry for formation of the dense part is applied to the end portion on the other side and then dried like in above-described Steps S13 and S14.

After the application and drying of the slurry at both the end portions of the support 11 are completed, the support 11 is placed into a sintering furnace and the slurry at both the end portions is sintered (Step S15). Sintering of the slurry is performed, for example, under the air atmosphere. Though the support 11 is supported in the horizontal orientation during sintering of the slurry in the present process example, the support 11 may be supported in any orientation. The sintering temperature is, for example, from 450° C. to 1200° C., and 1000° C. in the present process example. The rising and falling temperature rate is, for example, 100° C./h. The sintering time is, for example, 1 to 50 hours, and 3 hours in the present process example. By the above process, the dense part 13 is formed at both the end portions of the support 11. In a case where the slurry for formation of the dense part contains the glass powder, the dense part 13 is a glass seal part.

Subsequently, seed crystals to be used for forming the zeolite membrane 12 are prepared. In one exemplary case where the DDR-type zeolite membrane 12 is formed, DDR-type zeolite powder is synthesized by hydrothermal synthesis, and the seed crystals are acquired from the zeolite powder. The zeolite powder itself may be used as the seed crystals, or may be processed by pulverization or the like, to thereby acquire the seed crystals.

The support 11 is immersed in a dispersion liquid in which the seed crystals are dispersed, and the seed crystals are thereby adhered onto the support 11 (Step S16). Alternatively, the dispersion liquid in which the seed crystals are dispersed is brought into contact with a portion on the support 11 where the zeolite membrane 12 is to be formed, and the seed crystals are thereby adhered onto the support 11. A seed crystal adhesion support is thereby produced. In the present process example, on the inner peripheral surface of each through hole 111, the seed crystals are adhered onto a region between the dense parts 13 at both the end portions. Further, the seed crystals are also adhered onto the dense part 13 in the vicinity of the boundary position P1. In the support 11, masking or the like may be performed on a region on which the zeolite membrane 12 is not to be formed. The seed crystals may be adhered onto the support 11 by any other method.

The support 11 on which the seed crystals are adhered is immersed in a starting material solution. The starting material solution is produced, for example, by dissolving or dispersing an Si source and a structure-directing agent (hereinafter, also referred to as an “SDA”), and the like in a solvent. As the solvent of the starting material solution, for example, used is water or alcohol such as ethanol or the like. The SDA contained in the starting material solution is, for example, an organic substance. As the SDA, for example, 1-adamantanamine or the like can be used.

Then, the DDR-type zeolite is caused to grow from the seed crystals as nuclei by the hydrothermal synthesis, to thereby form the DDR-type zeolite membranes 12 on the support 11 (Step S17). The temperature in the hydrothermal synthesis is preferably 120 to 200° C. The time for hydrothermal synthesis is preferably 6 to 100 hours. The zeolite membranes 12 on the inner peripheral surface of the through hole 111 covers the inner peripheral surface from the boundary position P1 toward the side opposite to the dense part 13 and covers the dense part 13 in the vicinity of the boundary position P1.

After the hydrothermal synthesis is finished, the support 11 and the zeolite membrane 12 are washed with pure water. The support 11 and the zeolite membrane 12 after being washed are dried at, for example, 80° C. After drying of the support 11 and the zeolite membrane 12 is finished, a heat treatment is performed on the zeolite membrane 12 under an oxidizing gas atmosphere, to thereby burn and remove the SDA in the zeolite membrane 12 (Step S18). This allows micropores in the zeolite membrane 12 to come through the zeolite membrane 12. Preferably, the SDA is almost completely removed. The heating temperature for removing the SDA is, for example, from 300° C. to 700° C. The heating time is, for example, from 5 to 200 hours. The oxidizing gas atmosphere is an atmosphere containing oxygen and for example, the air. With the above processing, the separation membrane complex 1 is obtained.

Herein, a method of producing a separation membrane complex of Comparative Examples will be described. FIG. 8 is a cross-sectional view showing a separation membrane complex 8 of Comparative Example. In the production of the separation membrane complex 8 of Comparative Examples, after applying the slurry for formation of the dense part to an end portion on one side of a support 81 in Step S13 of FIG. 6, the slurry is dried in a horizontal orientation where through holes 811 are in parallel to the horizontal direction. Further, gas blowing along an inner peripheral surface is not performed. Processes in the other Steps S11, S12, and S15 to S18 are the same as those in the production of the separation membrane complex 1.

In the separation membrane complex 8 of Comparative Examples, on the inner peripheral surface of the through hole 811, a portion of a dense part 83 which is to be adhered to a region facing downward during drying of the slurry has a hanging-down shape due to the gravity effect. Therefore, the cross-sectional shape of the dense part 83 in the vicinity of the boundary position P1 largely varies along the circumferential direction of the inner peripheral surface. Actually, in the case where the above-described evaluation angle θ (see FIG. 5) is acquired with respect to each of four measurement positions set at 90-degree intervals in the circumferential direction on the inner peripheral surface, the four evaluation angles θ at the four measurement positions largely vary and the maximum value of the evaluation angles θ becomes larger than 45 degrees. At the measurement position where the evaluation angle θ becomes larger than 45 degrees, an angle at which a zeolite membrane 82 is bent in the vicinity of the boundary position P1 becomes larger and it becomes easier to occur a crack or the like of the zeolite membrane 82 due to the stress concentration or the like. As a result, the separation performance of the separation membrane complex 8 is degraded.

Further, in the separation membrane complex 8 of Comparative Examples, the projections and depressions of a surface of the dense part 83 in the vicinity of the boundary position P1 are easy to become larger, and a defect (hole portion or the like) is easy to occur in the dense part 83 and the zeolite membrane 82 formed on the dense part 83. Also in this case, the separation performance of the separation membrane complex 8 is degraded. Further, in a case where the cross-sectional shape of the dense part 83 largely varies along the circumferential direction of the inner peripheral surface, it is preferable that a position in the circumferential direction where the thickness of the dense part 83 on the inner peripheral surface is almost maximum should be included in the above-described four measurement positions.

On the other hand, in the separation membrane complex 1, in the case where the evaluation angle θ is acquired with respect to each of the four measurement positions set at 90-degree intervals in the circumferential direction on the inner peripheral surface of the through hole 111, the maximum value of the four evaluation angles θ at the four measurement positions is not smaller than 5 degrees and not larger than 45 degrees. The angle at which the zeolite membrane 12 is bent in the vicinity of the boundary position P1 thereby becomes smaller. As a result, it is possible to suppress occurrence of a crack or the like of the zeolite membrane 12 in the vicinity of the boundary position P1 and suppress degradation of the separation performance of the separation membrane complex 1.

In the preferable separation membrane complex 1, the angle of the range of the four evaluation angles θ at the four measurement positions is not larger than 15 degrees. Thus, in the separation membrane complex 1 where the evaluation angle θ does not largely vary depending on the position in the circumferential direction, it is possible to further suppress occurrence of a crack or the like of the zeolite membrane 12. Depending on the structure of the separation membrane complex 1, the angle of the range of the four evaluation angles θ at the four measurement positions may be larger than 15 degrees.

Preferably, within the specified range R1 of the cross section of the separation membrane complex 1, the average roughness Za of the surface of the dense part 13 which is calculated with the straight line L1 along the surface of the dense part 13 on the side of the zeolite membrane 12 as a reference is not less than 0.01 μm and not more than 10 μm. Even when the thickness of the zeolite membrane 12 is not larger than 5 μm, it is thereby possible to suppress occurrence of a defect (hole portion) in the zeolite membrane 12 due to the roughness of the surface of the dense part 13. As a matter of course, the thickness of the zeolite membrane 12 may be larger than 5 μm (the same applies to the following).

Further, it is preferable that the surface roughness Ra of the dense part 13 in the non-existent region of the zeolite membrane 12 should be not less than 0.01 μm and not more than 1 μm. Like the average roughness Za, even when the thickness of the zeolite membrane 12 is not larger than 5 μm, it is thereby possible to suppress occurrence of a defect (hole portion) in the zeolite membrane 12 due to the roughness of the surface of the dense part 13. As described later, since the surface of the dense part 13 in the non-existent region of the zeolite membrane 12 is a surface with which a sealing member 23 (see FIG. 10) comes into close contact, it is possible to increase the sealing performance between the sealing member 23 and the dense part 13.

Within the specified range R1 where the thickness of the dense part 13 is relatively thin, in a case where there are many closed pores in the dense part 13, a portion around the closed pore is broken with a stress acting on the dense part 13 and the portion sometimes becomes the starting point of a crack. In this case, there sometimes occurs delamination between the dense part 13 and the zeolite membrane 12. On the other hand, in the preferable separation membrane complex 1, within the specified range R1, the closed porosity in the dense part 13 is 10% or less. It is thereby possible to suppress occurrence of a crack or the like in the dense part 13 with the closed pore as the starting point and suppress occurrence of delamination between the dense part 13 and the zeolite membrane 12.

In the preferable separation membrane complex 1, the boundary position P1 is provided at the end portion of the support 11 on the one side in the longitudinal direction and the dense part 13 also covers the end surface of the support 11 on the one side. It is thereby possible for the dense part 13 to appropriately seal not only the end portion on the one side on the inner peripheral surface of the through hole 111 but also the end surface on the one side of the support 11. Depending on the structure of the separation membrane complex 1, the dense part 13 may not be provided in the end surface of the support 11.

In the method of producing the separation membrane complex 1, assuming one position in the longitudinal direction on the inner peripheral surface of the through hole 111 as the boundary position P1, the slurry for formation of the dense part is so applied as to cover the inner peripheral surface from the boundary position P1 toward the one side in the longitudinal direction. The viscosity of the slurry for formation of the dense part is not lower than 2 dPa·s and not higher than 30 dPa·s. Further, the slurry is dried in the state where the end portion on the one side of the support 11 in the longitudinal direction is arranged on a lower side and the end portion on the other side is arranged on an upper side. Alternatively, the slurry is dried by blowing gas along the inner peripheral surface from the other side toward the one side. Then, by sintering the slurry, the dense part 13 is formed. After that, on the inner peripheral surface of the support 11, the zeolite membrane 12 is so formed as to cover the inner peripheral surface from the boundary position P1 toward the other side in the longitudinal direction and cover the dense part 13 in the vicinity of the boundary position P1. It is thereby possible to easily produce the separation membrane complex 1 which makes it possible to suppress occurrence of a crack or the like of the zeolite membrane 12 in the vicinity of the boundary position P1.

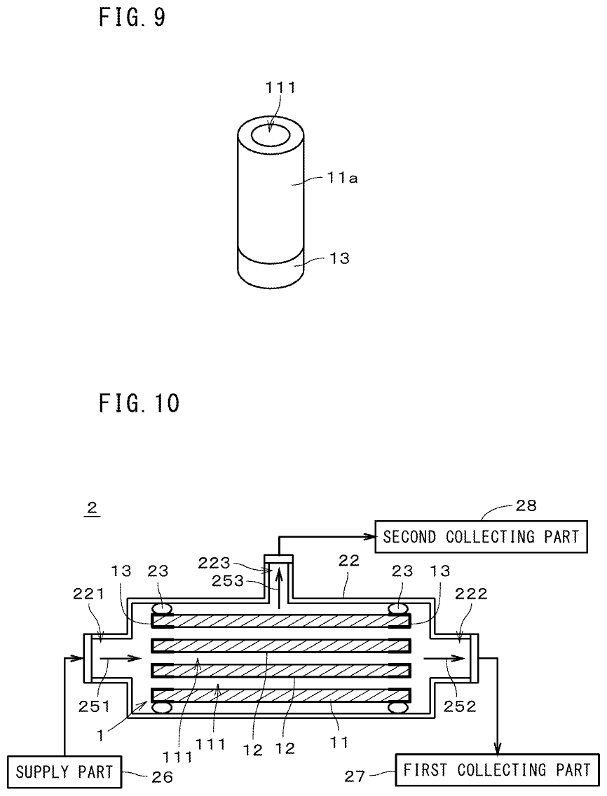

Next, Examples of the separation membrane complex will be described. In Example 1, methyl cellulose as an organic binder is added to glass powder having an average particle diameter of 10 μm, which is a material of a dense part, and water is further added thereto, to be mixed, and the slurry is thereby obtained. By degassing the slurry for 1 hour in a vacuum desiccator while stirring the slurry, a slurry for formation of the dense part is prepared. The viscosity of the slurry for formation of the dense part at 20° C. is 2 dPa·s. For the measurement of the viscosity, used is the ultrasonic desktop viscosity meter (FCV-100H manufactured by Fuji Ultrasonic Engineering Co., Ltd.). Subsequently, a tubular alumina porous support (see FIG. 9) having a diameter of 10 mm and a length of 160 mm is prepared. A lower end portion of the support is immersed in the slurry for formation of the dense part in a vertical orientation where the through hole of the support is substantially in parallel to the up-and-down direction. After that, the support is pulled up at a speed of 1 cm/s. After applying the slurry, the slurry is dried for 24 hours at room temperature while the support is held without changing the orientation (in the vertical orientation). After drying is completed, by placing the support into an electric furnace and sintering the slurry under the air atmosphere, the dense part which is the glass seal part is formed. The sintering is performed at 1000° C. for 3 hours, and the rising and falling temperature rate is 100° C./h.

Example 2 is the same as Example 1 except that the amount of methyl cellulose to be added is increased and the viscosity of the slurry for formation of the dense part is 10 dPa·s. Example 3 is the same as Example 1 except that the amount of methyl cellulose to be added is further increased and the viscosity of the slurry for formation of the dense part is 30 dPa·s.

In Example 4, after applying the slurry for formation of the dense part, the slurry is dried by blowing gas at a gas-blowing speed of 15 m/s from an upper end portion toward the lower end portion of the support while the support is held without changing the orientation (in the vertical orientation). The processes other than the above are the same as those in Example 2.

In Example 5, after applying the slurry for formation of the dense part, the orientation of the support is changed to a horizontal orientation, and the slurry is dried by blowing gas at a gas-blowing speed of 15 m/s from an end portion at which no slurry is applied toward an end portion of the support at which the slurry is applied. The processes other than the above are the same as those in Example 2.

Example 6 is the same as Example 1 except that for preparing the slurry for formation of the dense part, vacuum degassing is not performed and a defoamer (KM-73 manufactured by Shin-Etsu Chemical Co., Ltd.) is added by 0.1%.

In Comparative Example 1, methyl cellulose as an organic binder is added to glass powder having an average particle diameter of 10 μm, which is a material of a dense part, and water is further added thereto, to be mixed, and the slurry is thereby obtained. By degassing the slurry for 1 hour in the vacuum desiccator while stirring the slurry, a slurry for formation of the dense part is prepared. The viscosity of the slurry for formation of the dense part is 2 dPa·s. Subsequently, the lower end portion of the alumina porous support in the vertical orientation is immersed in the slurry for formation of the dense part, and after that, the support is pulled up at a speed of 1 cm/s. After applying the slurry, the orientation of the support is changed to a horizontal orientation and the slurry is dried for 24 hours at room temperature. After drying is completed, by placing the support into the electric furnace and sintering the slurry under the air atmosphere, the dense part is formed. The sintering is performed at 1000° C. for 3 hours, and the rising and falling temperature rate is 100° C./h.

In Comparative Example 2, ethanol is added to glass powder having an average particle diameter of 10 μm, which is a material of a dense part, to be mixed, and the slurry for formation of the dense part is thereby prepared. Subsequently, the lower end portion of the support in the vertical orientation is immersed in the slurry for formation of the dense part, and after that, the support is pulled up at a speed of 1 cm/s. After applying the slurry, the slurry is dried for 1 hours at room temperature while the support is held without changing the orientation (in the vertical orientation). After drying is completed, by placing the support into the electric furnace and sintering the slurry under the air atmosphere, the dense part is formed. The sintering is performed at 1000° C. for 3 hours, and the rising and falling temperature rate is 100° C./h.

Comparative Example 3 is the same as Comparative Example 1 except that the glass powder has an average particle diameter of 20 μm. Comparative Example 4 is the same as Comparative Example 1 except that the amount of methyl cellulose to be added is increased and the viscosity of the slurry for formation of the dense part is 40 dPa·s.

Next, various measurements are performed on the dense part on the support, which is formed as each of Examples 1 to 6 and Comparative Examples 1 to 4. Table 1 shows measurement results on the dense part. In Table 1, the viscosity of slurry for formation of the dense part and the orientation of the support during drying of the slurry are also shown.

TABLE 1

| | | | Maximum | Range | | | |
|---|---|---|---|---|---|---|---|
| | | | Value of | of | Average | | |
| | Slurry | Orientation | Evaluation | Evaluation | Roughness | | |
| | Viscosity | of | Angle | Angle | Za | Closed | Separation |
| | [dPa · s] | Support | [Degrees] | [Degrees] | [μm] | Porosity | Performance |
| Example 1 | 2 | Vertical | 10 | 0.5 | 0.2 | <10% | 250 |
| Example 2 | 10 | Vertical | 20 | 1 | 0.5 | <10% | 200 |
| Example 3 | 30 | Vertical | 40 | 5 | 0.5 | <10% | 150 |
| Example 4 | 10 | Vertical | 15 | 1 | 2 | <10% | 200 |
| | | (Gas Blowing) | | | | | |
| Example 5 | 10 | Horizontal | 30 | 10 | 3 | <10% | 150 |
| | | (Gas Blowing) | | | | | |
| Example 6 | 2 | Vertical | 15 | 0.5 | 0.2 | <10% | 250 |
| Comparative | 2 | Horizontal | 48 | 30 | 0.2 | <10% | 50 |
| Example 1 | | | | | | | |
| Comparative | 0.1 | Vertical | 50 | 10 | 2 | <10% | 40 |
| Example 2 | | | | | | | |
| Comparative | 15 | Horizontal | 50 | 20 | 11 | <10% | 43 |
| Example 3 | | | | | | | |
| Comparative | 40 | Horizontal | 60 | 15 | 5 | <10% | 20 |
| Example 4 | | | | | | | |

The measurement of the evaluation angle is performed on the dense part 13 formed on an outer peripheral surface of a support 11a shown in FIG. 9. With respect to each of four measurement positions set at 90-degree intervals in the circumferential direction on the outer peripheral surface which is a cylindrical surface, a cross section of the support 11a along the longitudinal direction is imaged by the SEM (Scanning Electron Microscope) and a SEM image is thereby acquired. The magnification of the SEM image is 1000 times. As has been described with reference to FIGS. 4 and 5, in the SEM image, set is a specified range R1 which is a range from the boundary position P1 which is a tip of the dense part 13 toward the end surface side in the longitudinal direction up to 30 μm. Subsequently, within the specified range R1, a maximum angle among angles formed of an outer peripheral surface of the support 11a and lines connecting respective positions on the surface of the dense part 13 (which corresponds to an interface between the dense part 13 and the zeolite membrane 12) and the boundary position P1 is acquired as an evaluation angle θ.

In the column of “Maximum Value of Evaluation Angle” in Table 1, shown is the maximum value of the four evaluation angles at the four measurement positions. In each of Examples 1 to 6, the maximum value of the evaluation angles is not smaller than 5 degrees and not larger than 45 degrees, and in more detail, not smaller than 10 degrees and not larger than 40 degrees. On the other hand, in each of Comparative Examples 1 to 4, the maximum value of the evaluation angles is larger than 45 degrees.

In the column of “Range of Evaluation Angle” in Table 1, shown is an angle of the range of the four evaluation angles at the four measurement positions. In Examples 1 to 6, the range of the evaluation angles is not larger than 15 degrees, and in Examples except Example 5, the range of the evaluation angles is smaller than 10 degrees. On the other hand, in each of Comparative Examples 1 to 4, the range of the evaluation angles is not smaller than 10 degrees.

“Average Roughness Za” in Table 1 is measured by the already-described method which has been described, with reference to FIG. 5. Specifically, first, like the measurement of the evaluation angle, a SEM image representing the cross section of the support 11a is acquired. Subsequently, within the specified range R1, a straight line L1 along the surface of the dense part 13 (which corresponds to the interface between the dense part 13 and the zeolite membrane 12) is set. Then, the surface roughness Za of the dense part 13 is obtained from Eq. 1 and an average value of roughnesses Za at the four measurement positions is determined as the average roughness Za. In each of Examples 1 to 6, the average roughness Za is not less than 0.01 μm and not more than 10 μm, and in more detail, not more than 3 μm. On the other hand, in each of Comparative Examples 1 to 4 except Comparative Example 1, the average roughness Za is not less than 2 μm, and in each of Comparative Examples 3 and 4, the average roughness Za is not less than 5 μm.

In the calculation of “Closed Porosity” in Table 1, in the SEM image representing the cross section of the support 11a, within the specified range R1, the area of the dense part 13 and the area of the closed pore are calculated, and the closed porosity in the SEM image is obtained by dividing the area of the closed pore by the area of the dense part 13. Then, an average value of the closed porosities in ten SEM images is determined as the closed porosity of the dense part 13. In each of Examples 1 to 6 and Comparative Examples 1 to 4, the closed porosity of the dense part 13 is lower than 10%.

Though not shown in FIG. 1, the surface roughness Ra of the dense part 13 at a position away from the boundary position P1 (which corresponds to the non-existent region of the zeolite membrane 12) is also measured. In the measurement of the surface roughness Ra, surface roughnesses Ra at ten portions on the surface of the dense part 13 are measured by using the general-purpose three-dimensional surface structure analysis apparatus (NewView 7300 manufactured by Zygo Corporation) where the magnification of objective lens is 50 times and the zoom is one time. Then, an average value of the ten surface roughnesses Ra is determined as the surface roughness Ra of the dense part 13. In each of Examples 1 to 6, the surface roughness Ra of the dense part 13 is not less than 0.01 μm and not more than 1 μm.

Next, on the support 11a in each of Examples 1 to 6 and Comparative Examples 1 to 4, the zeolite membrane is formed. In the formation of the zeolite membrane, seed crystals of the DDR-type zeolite are adhered to the outer peripheral surface of the support 11a. Subsequently, by mixing silica, 1-adamantanamine, ethylenediamine, and water, a starting material solution is prepared. It is assumed that the ratio of the components in the starting material solution is 1:10:0.25:100 at the weight ratio. After placing the support 11a on which the seed crystals of the DDR-type zeolite are adhered into a fluororesin inner cylinder (internal volume: 300 ml) of a stainless pressure-resistant container, the starting material solution (sol for film formation) is put therein and a heat treatment (hydrothermal synthesis at 130° C. for 24 hours) is performed, to thereby form a high silica DDR-type zeolite membrane. After washing the support 11a with pure water, the support 11a is dried at 80° C. for 12 hours or more. After that, by raising the temperature of the support 11a to 450° C. in the electric furnace and keeping the temperature thereof for 50 hours, 1-adamantanamine is burned and removed and a DDR-type zeolite membrane is thereby obtained.

Subsequently, the separation performance of the support 11a on which the zeolite membrane is formed (i.e., the separation membrane complex) is measured. In the measurement of the separation performance, first, a mixed gas of carbon dioxide and methane at 25° C. (volume ratio of the gases=50:50) is fed into a cell (through hole 111) of the support 11a at 0.3 MPa and the respective gas concentrations on the supply side and the permeate side which are separated from each other with the zeolite membrane are measured. Then, the separation performance a is calculated on the basis of Eq. 2.

$$α = \frac{\begin{matrix}( {CO}_{2} concentration on permeate \\ side / {CH}_{4} concentration on permeate side )\end{matrix}}{\begin{matrix}( {CO}_{2} concentration on supply \\ side / {CH}_{4} concentration on supply side )\end{matrix}} \qquad ( Eq . 2 )$$

A calculation result of the separation performance is as shown in Table 1. Further, the separation performance in Table 1 is a value standardized with a predetermined value as a reference. In the separation membrane complex in each of Examples 1 to 6, sufficiently high separation performance is obtained as compared with the separation membrane complex in each of Comparative Examples 1 to 4. By observation of the cross section of the separation membrane complex in each of Comparative Examples by using the SEM, occurrence of a crack in the zeolite membrane is recognized.

Next, separation of a mixed substance by using the separation membrane complex will be described. Though the separation membrane complex 1 shown in FIG. 1 is used in the following description, the same applies to the case where the separation membrane complex having the tubular support 11a shown in FIG. 9 is used. FIG. 10 is a view showing a separation apparatus 2.

In the separation apparatus 2, a mixed substance containing a plurality of types of fluids (i.e., gases or liquids) is supplied to the separation membrane complex 1, and a substance with high permeability in the mixed substance is caused to permeate the separation membrane complex 1, to be thereby separated from the mixed substance. Separation in the separation apparatus 2 may be performed, for example, in order to extract a substance with high permeability from a mixed substance, or in order to concentrate a substance with low permeability.

The mixed substance (i.e., mixed fluid) may be a mixed gas containing a plurality of types of gases, may be a mixed liquid containing a plurality of types of liquids, or may be a gas-liquid two-phase fluid containing both a gas and a liquid.

The mixed substance contains at least one of, for example, hydrogen (H₂), helium (He), nitrogen (N₂), oxygen (O₂), water (H₂O), water vapor (H₂O), carbon monoxide (CO), carbon dioxide (CO₂), nitrogen oxide, ammonia (NH₃), sulfur oxide, hydrogen sulfide (H₂S), sulfur fluoride, mercury (Hg), arsine (AsH₃), hydrogen cyanide (HCN), carbonyl sulfide (COS), C1 to C8 hydrocarbons, organic acid, alcohol, mercaptans, ester, ether, ketone, and aldehyde.

The nitrogen oxide is a compound of nitrogen and oxygen. The above-described nitrogen oxide is, for example, a gas called NOx such as nitric oxide (NO), nitrogen dioxide (NO₂), nitrous oxide (also referred to as dinitrogen monoxide) (N₂O), dinitrogen trioxide (N₂O₃), dinitrogen tetroxide (N₂O₄), dinitrogen pentoxide (N₂O₅), or the like.

The sulfur oxide is a compound of sulfur and oxygen. The above-described sulfur oxide is, for example, a gas called SO_{X} such as sulfur dioxide (SO₂), sulfur trioxide (SO₃), or the like.

The sulfur fluoride is a compound of fluorine and sulfur. The above-described sulfur fluoride is, for example, disulfur difluoride (F—S—S—F, S═SF₂), sulfur difluoride (SF₂), sulfur tetrafluoride (SF₄), sulfur hexafluoride (SF₆), disulfur decafluoride (S₂F₁₀), or the like.

The C1 to C8 hydrocarbons are hydrocarbons with not less than 1 and not more than 8 carbon atoms. The C3 to C8 hydrocarbons may be any one of a linear-chain compound, a side-chain compound, and a ring compound. Further, the C2 to C8 hydrocarbons may either be a saturated hydrocarbon (i.e., in which there is no double bond or triple bond in a molecule), or an unsaturated hydrocarbon (i.e., in which there is a double bond and/or a triple bond in a molecule). The C1 to C4 hydrocarbons are, for example, methane (CH₄), ethane (C₂H₆), ethylene (C₂H₄), propane (C₃H₈), propylene (C₃H₆), normal butane (CH₃(CH₂)₂CH₃), isobutane (CH (CH₃)₃), 1-butene (CH₂═CHCH₂CH₃), 2-butene (CH₃CH═CHCH₃), or isobutene (CH₂═C(CH₃)₂).

The above-described organic acid is carboxylic acid, sulfonic acid, or the like. The carboxylic acid is, for example, formic acid (CH₂O₂), acetic acid (C₂H₄O₂), oxalic acid (C₂H₂O₄), acrylic acid (C₃H₄O₂), benzoic acid (C₆H₅COOH), or the like. The sulfonic acid is, for example, ethanesulfonic acid (C₂H₆O₃S) or the like. The organic acid may either be a chain compound or a ring compound.

The above-described alcohol is, for example, methanol (CH₃OH), ethanol (C₂H₅OH), isopropanol (2-propanol) (CH₃CH(OH)CH₃), ethylene glycol (CH₂(OH)CH₂(OH)), butanol (C₄H₉OH), or the like.

The mercaptans are an organic compound having hydrogenated sulfur (SH) at the terminal end thereof, and are a substance also referred to as thiol or thioalcohol. The above-described mercaptans are, for example, methyl mercaptan (CH₃SH), ethyl mercaptan (C₂H₅SH), 1-propanethiol (C₃H₇SH), or the like.

The above-described ester is, for example, formic acid ester, acetic acid ester, or the like.

The above-described ether is, for example, dimethyl ether ((CH₃)₂O), methyl ethyl ether (C₂H₅OCH₃), diethyl ether ((C₂H₅)₂O), or the like.

The above-described ketone is, for example, acetone ((CH₃)₂CO), methyl ethyl ketone (C₂H₅COCH₃), diethyl ketone ((C₂H₅)₂CO), or the like.

The above-described aldehyde is, for example, acetaldehyde (CH₃CHO), propionaldehyde (C₂H₅CHO), butanal (butylaldehyde) (C₃H₇CHO), or the like.

In the following description, it is assumed that the mixed substance separated by the separation apparatus 2 is a mixed gas containing a plurality of types of gases.

The separation apparatus 2 shown in FIG. 10 includes the separation membrane complex 1, a housing 22, two sealing members 23, a supply part 26, a first collecting part 27, and a second collecting part 28. The separation membrane complex 1 and the sealing members 23 are accommodated in the housing 22. The supply part 26, the first collecting part 27, and the second collecting part 28 are disposed outside the housing 22 and connected to the housing 22.

There is no particular limitation on the shape of the housing 22 but is, for example, a tubular member having a substantially cylindrical shape. The housing 22 is formed of, for example, stainless steel or carbon steel. The longitudinal direction of the housing 22 is substantially in parallel to the longitudinal direction of the separation membrane complex 1. A supply port 221 is provided at an end portion on one side in the longitudinal direction of the housing 22 (i.e., an end portion on the left side in this figure), and a first exhaust port 222 is provided at another end portion on the other side. A second exhaust port 223 is provided on a side surface of the housing 22. The supply part 26 is connected to the supply port 221. The first collecting part 27 is connected to the first exhaust port 222. The second collecting part 28 is connected to the second exhaust port 223. An internal space of the housing 22 is a sealed space that is isolated from the space around the housing 22.

The two sealing members 23 are arranged around the entire circumference between an outer peripheral surface of the separation membrane complex 1 and an inner peripheral surface of the housing 22 in the vicinity of both end portions of the separation membrane complex 1 in the longitudinal direction. Each of the sealing members 23 is a substantially annular member formed of a material that gas cannot permeate. The sealing member 23 is, for example, an O-ring formed of a flexible resin. The sealing members 23 come into close contact with the outer peripheral surface of the separation membrane complex 1 and the inner peripheral surface of the housing 22 around the entire circumferences thereof. In more detail, the sealing member 23 comes into close contact with the dense part 13 on the outer peripheral surface of the support 11 and indirectly comes into close contact with the outer peripheral surface of the support 11 through the dense part 13. The portions between the sealing member 23 and the outer peripheral surface of the separation membrane complex 1 and between the sealing member 23 and the inner peripheral surface of the housing 22 are sealed, and it is thereby mostly or completely impossible for gas to pass through the portions. In the separation apparatus 2, the hermeticity between the second exhaust port 223 and the supply port 221 and the first exhaust port 222 is ensured by the sealing members 23.

The supply part 26 supplies the mixed gas into the internal space of the housing 22 through the supply port 221. The supply part 26 includes, for example, a blower or a pump for pumping the mixed gas toward the housing 22. The blower or the pump includes a pressure regulating part for regulating the pressure of the mixed gas to be supplied to the housing 22. The first collecting part 27 and the second collecting part 28 each include, for example, a storage container for storing the gas led out from the housing 22 or a blower or a pump for transporting the gas.

When separation of the mixed gas is performed, the above-described separation apparatus 2 is prepared. Subsequently, the supply part 26 supplies a mixed gas containing a plurality of types of gases with different permeabilities for the zeolite membrane 12 into the internal space of the housing 22. For example, the main component of the mixed gas includes CO₂ and CH₄. The mixed gas may contain any gas other than CO₂ and CH₄. The pressure (i.e., feed pressure) of the mixed gas to be supplied into the internal space of the housing 22 from the supply part 26 is, for example, 0.1 MPa to 20.0 MPa. The temperature for separation of the mixed gas is, for example, 10° C. to 150° C.

The mixed gas supplied from the supply part 26 into the housing 22 is fed from the left end of the separation membrane complex 1 in this figure into the inside of each through hole 111 of the support 11 as indicated by an arrow 251. Gas with high permeability (which is, for example, CO₂, and hereinafter is referred to as a “high permeability substance”) in the mixed gas permeates the zeolite membrane 12 provided on the inner peripheral surface of each through hole 111 and the support 11, and is led out from the outer peripheral surface of the support 11. The high permeability substance is thereby separated from gas with low permeability (which is, for example, CH₄, and hereinafter is referred to as a “low permeability substance”) in the mixed gas.

The gas (hereinafter, referred to as a “permeate substance”) passing through the separation membrane complex 1 and led out from the outer peripheral surface of the support 11 is collected by the second collecting part 28 through the second exhaust port 223 as indicated by an arrow 253. The pressure (i.e., permeate pressure) of the gas to be collected by the second collecting part 28 through the second exhaust port 223 is, for example, about 1 atmospheric pressure (0.101 MPa).

Further, in the mixed gas, gas (hereinafter, referred to as a “non-permeate substance”) other than the gas which has permeated the zeolite membrane 12 and the support 11 passes through each through hole 111 of the support 11 from the left side to the right side in this figure and is collected by the first collecting part 27 through the first exhaust port 222 as indicated by an arrow 252. The pressure of the gas to be collected by the first collecting part 27 through the first exhaust port 222 is, for example, substantially the same as the feed pressure. The non-permeate substance may include a high permeability substance that has not permeated the zeolite membrane 12, as well as the above-described low permeability substance.

In the above-described separation membrane complex 1 and the above-described method of producing the separation membrane complex 1, various modifications can be made.

Depending on the design of the separation membrane complex, the zeolite membrane 12 and the dense part 13 may be provided on the outer peripheral surface of the monolith-type support 11 shown in FIG. 1, or may be provided on the inner peripheral surface of the tubular support 11a shown in FIG. 9.

As described earlier, the support may be a flat plate and the dense part 13 and the zeolite membrane 12 may be formed on one main surface of the support. In this case, the production of the separation membrane complex 1 is performed as follows. First, a slurry for formation of a dense part is so applied as to cover the main surface of the porous support from a position defined as the boundary position in a predetermined direction on the main surface toward one side in the predetermined direction. The viscosity of the slurry for formation of the dense part is not lower than 2 dPa·s and not higher than 30 dPa·s. Further, the slurry is dried in a state where an end portion on the one side of the support in the predetermined direction is arranged on a lower side and an end portion on the other side is arranged on an upper side. Alternatively, the slurry is dried by blowing gas along the main surface from the other side of the support toward the one side. Then, by sintering the slurry, the dense part 13 is formed. The dense part 13 covers the main surface from the boundary position toward one side in the predetermined direction on the main surface. After that, formed is the zeolite membrane 12 which covers the main surface from the boundary position toward the other side in the predetermined direction on the main surface and also covers the dense part 13 in the vicinity of the boundary position.

In the separation membrane complex 1 obtained by the above-described production method, in a case where with respect to each of the four measurement positions set equally in a direction perpendicular to the predetermined direction on the main surface, the evaluation angle is acquired in the cross section perpendicular to the main surface and along the predetermined direction, the maximum value of the four evaluation angles at the four measurement positions is not smaller than 5 degrees and not larger than 45 degrees. In the separation membrane complex 1, it is thereby possible to suppress occurrence of a crack or the like of the zeolite membrane 12 in the vicinity of the boundary position and suppress degradation of separation performance of the separation membrane complex 1. Further, the predetermined direction corresponds to the longitudinal direction of the support 11 of FIG. 1 or the support 11a of FIG. 9. The separation membrane complex 1 may be manufactured by a method other than the above-described production method.

In the separation membrane complex 1, within the specified range R1, the closed porosity in the dense part 13 may be higher than 10%. The average roughness Za of the surface of the dense part 13 within the specified range R1 may be less than 0.01 μm or more than 10 μm, and the surface roughness Ra of the dense part 13 in the non-existent region of the zeolite membrane 12 may be less than 0.01 μm or more than 1 μm.

Depending on the use of the separation membrane complex 1, the zeolite membrane 12 may include the SDA.

The separation membrane complex 1 may further include a function layer or a protective layer laminated on the zeolite membrane 12, additionally to the support 11, the dense part 13, and the zeolite membrane 12. Such a function layer or a protective layer may be an inorganic membrane such as the zeolite membrane, a silica membrane, a carbon membrane, or the like or an organic membrane such as a polyimide membrane, a silicone membrane, or the like. Further, a substance that is easy to adsorb specific molecules such as CO₂ or the like may be added to the function layer or the protective layer laminated on the zeolite membrane 12.

In the separation apparatus 2 including the separation membrane complex 1, any substance other than the substances exemplarily shown in the above description may be separated from the mixed substance.

The configurations in the above-described preferred embodiment and variations may be combined as appropriate only if those do not conflict with one another.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

The separation membrane complex of the present invention can be used as, for example, a gas separation membrane, and can be further used in various fields, as a separation membrane for any substance other than gas, an adsorption membrane for various substances, or the like.

### REFERENCE SIGNS LIST

1 Separation membrane complex
11, 11a Support
12 Zeolite membrane
13 Dense part
P1 Boundary position
R1 Specified range
S11 to S18 Step
θ Evaluation angle

1. A separation membrane complex, comprising:
a porous support;
a dense part covering one surface of said support from a position defined as a boundary position in a predetermined direction on said surface toward one side in said predetermined direction; and
a separation membrane covering said surface of said support from said boundary position toward the other side in said predetermined direction on said surface and covering said dense part in vicinity of said boundary position,
wherein in a case where with respect to each of four measurement positions set equally in a direction perpendicular to said predetermined direction on said surface of said support, in a cross section perpendicular to said surface of said support and along said predetermined direction, within a specified range from said boundary position toward said one side in said predetermined direction up to 30 μm, a maximum angle among angles formed of said surface of said support and lines connecting respective positions on a surface of said dense part on a side of said separation membrane and said boundary position is acquired as an evaluation angle, a maximum value of four evaluation angles at said four measurement positions is not smaller than 5 degrees and not larger than 45 degrees.

2. The separation membrane complex according to claim 1, wherein
a closed porosity in said dense part is not higher than 10% within said specified range of said cross section.

3. The separation membrane complex according to claim 1, wherein
a thickness of said separation membrane is not larger than 5 μm, and
within said specified range of said cross section, an average roughness of said surface of said dense part on said side of said separation membrane is not less than 0.01 μm and not more than 10 μm, said average roughness being calculated with a straight line along said surface of said dense part as a reference.

4. The separation membrane complex according to claim 1, wherein
a thickness of said separation membrane is not larger than 5 μm, and
a surface roughness Ra of said dense part in a non-existent region of said separation membrane is not less than 0.01 μm and not more than 1 μm.

5. The separation membrane complex according to claim 1, wherein
said surface of said support is a cylindrical surface along said predetermined direction,
said four measurement positions are set on said cylindrical surface at 90-degree intervals in a circumferential direction, and
an angle of a range of said four evaluation angles at said four measurement positions is not larger than 15 degrees.

6. The separation membrane complex according to claim 1, wherein
said surface of said support is a cylindrical surface along said predetermined direction,
said boundary position is provided at an end portion of said support on said one side in said predetermined direction, and
said dense part covers an end surface of said support on said one side.

7. A method of producing a separation membrane complex, comprising:
a) applying a slurry for formation of a dense part so as to cover one surface of a porous support from a position defined as a boundary position in a predetermined direction on said surface toward one side in said predetermined direction;
b) drying said slurry in a state where an end portion on said one side of said support in said predetermined direction is arranged on a lower side and an end portion on the other side is arranged on an upper side, or drying said slurry by blowing gas along said surface from said other side of said support toward said one side;
c) forming a dense part by sintering said slurry; and
d) forming a separation membrane which covers said surface of said support from said boundary position toward said other side in said predetermined direction on said surface and covers said dense part in vicinity of said boundary position,
wherein a viscosity of said slurry in said operation a) is not lower than 2 dPa·s and not higher than 30 dPa·s.
